(19) United States
(12) Patent Application Publication
(10) Pub. No.: US 2025/0004156 A1
(43) Pub. Date: Jan. 2, 2025

(54) SUBSURFACE FLUID DETECTION

(71) Applicant: WILLOWSTICK TECHNOLOGIES, LLC, Draper, UT (US)

(72) Inventors: Michael L. JESSOP, Eagle Mountain, UT (US); David J. LUKER, Sandy, UT (US); Justin A. COOK, Herriman, UT (US); Val O. KOFOED, Spanish Fork, UT (US)

(21) Appl. No.: 18/760,373

(22) Filed: Jul. 1, 2024

Related U.S. Application Data
(60) Provisional application No. 63/511,523, filed on Jun. 30, 2023.

(51) Int. Cl. G01V 1/36; G01V 1/24; G01V 5/00

(52) U.S. Cl. CPC G01V 1/364; G01V 1/245; G01V 5/00; G01V 2210/1234; G01V 2210/1299; G01V 2210/1425; G01V 2210/21

(57) ABSTRACT

A method of detecting subsurface conditions conducive to fluid transfer can include obtaining microseismic resonance signals from multiple surface locations over a subsurface region of interest using a resonance sensor, wherein for at least a plurality of the multiple surface locations, multiple microseismic resonance signals are obtained at different times to generate signal stacks. In some examples, the method can also include amplifying the microseismic resonance signals, filtering out the high frequencies at least above about 7,500 Hz leaving low frequencies at least as low as about 4 Hz for evaluation, and using these low frequencies to identify subsurface fracture zones where subsurface fluid may be present. In some examples, subsurface fluids can be detected and/or mapped using gamma radiation count and/or magnetometric density data collected using appropriate equipment.

The present application claims the benefit of U.S. Provisional Patent Application No. 63/511,523, filed Jun. 30, 2023, the entirety of which is incorporated herein by reference.

### BACKGROUND

Current techniques for tracking groundwater or subsurface fluids typically involve geophysical methods such as various forms of galvanic resistivity, electromagnetic conductivity, nuclear magnetic resonance, or the drilling of many observation wells for monitoring. Other forms of tracking and monitoring rely on the measurement of magnetic fields created by electric currents flowing through underground water pathways, often referred to as the magnetometric approach. Drilling is an option for identifying and/or tracking subsurface water, but this can be a lengthy and expensive process with much guesswork involved.

### BRIEF DESCRIPTION OF THE DRAWINGS

FIG. 1 schematically illustrates an example device or system for detecting subsurface water from microseismic resonance (MSR) in accordance with the present disclosure;

FIG. 2 schematically illustrates an example device or system for detecting subsurface water based on near-surface gamma radiation emission in accordance with the present disclosure;

FIG. 3 schematically illustrates an example device or system for detecting subsurface water using magnetometric density (MMD) in accordance with the present disclosure;

FIG. 4 illustrates example subsurface signal collected from a region of land using microseismic resonance technology in accordance with the present disclosure;

FIG. 5 illustrates example subsurface signal collected from a region of land using gamma radiation technology in accordance with the present disclosure;

FIG. 6 illustrates example subsurface signal collected from a region of land using magnetometric density technology in accordance with the present disclosure;

FIG. 7 is a schematic drawing depicting a subsurface cross-sectional area of interest showing information that can be ascertained by the use of multiple subsurface detection technologies in accordance with the present disclosure; and

FIG. 8 provides comparative subsurface microseismic resonance measurements which illustrates enhanced resolution that can be obtained by using signal stacking.

### DETAILED DESCRIPTION

The technology described herein can use the detection of one or more of microseismic resonance, gamma radiation, and/or magnetometric field to detect subsurface fluids, particularly water, with reasonable accuracy. As an initial note, when referring to “detecting” subsurface fluids herein, this includes fluid discovery, fluid mapping, fluid monitoring, and/or detecting conditions highly conducive to fluid transport which may enable extension of the typical wellbore reach and thereby increase production. In some instances where other fluids, such as oil or methane or the like, are being targeted even for deep discovery, microseismic resonance can be a particularly useful tool. Furthermore, when referring to “subsurface” fluids or “subsurface body of” fluid, e.g., water, oil, gas, etc., this includes any fluid content beneath the surface being tested, including reservoirs of subsurface fluids, flowing subsurface fluids, subsurface springs under pressure, subsurface moisture content contained with earth material such as fields of rock, gravel, sand, clay, etc., subsurface reservoirs of hydrocarbons, e.g., oil or gas, or any other subsurface dispersed or pooled collection of fluids that may be found beneath a surface of the earth or other large structure, e.g., industrial underground water channels, fluids coursing through a dam, etc. In accordance with this, a method of detecting subsurface conditions conducive to fluid transfer can include obtaining microseismic resonance signals from multiple surface locations over a subsurface region of interest using a resonance sensor or sensors, e.g., piezoelectric sensor(s) or other sensors suitable for use with geophones. For at least a plurality of the multiple surface locations, multiple microseismic resonance signals can be obtained at different times to generate signal stacks. This method can also include amplifying the microseismic resonance signals, filtering out the high frequencies at least above about 7,500 Hz leaving low frequencies at least as low as about 4 Hz for evaluation, and using these low frequencies to identify subsurface fracture zones where subsurface fluid may be present. In some examples, filtering out the high frequencies may include retaining all low frequencies below the high frequencies that are filtered out, e.g., everything below 7,500 Hz is kept.

In another example, a method of detecting subsurface water or conditions conducive to subsurface water can include obtaining a gamma radiation count from multiple surface locations over a subsurface region of interest using a gamma radiation detector having an inorganic scintillation detector selected from a cesium halide crystal, cerium halide crystal, lanthanum halide crystal, or bismuth germinate crystal. This method can also include determining a background gamma radiation count over at least a portion of the subsurface region of interest, and identifying a potential subsurface water location within the region of interest where a reduced gamma radiation count is present relative to the background gamma radiation count.

In another example, a system of detecting subsurface conditions conducive to fluid transfer can include a microseismic resonance detector with a resonance sensor, e.g., piezoelectric sensor(s) or other sensor(s), to obtain microseismic resonance signals from multiple surface locations over a subsurface region of interest. The system can also include an analog amplifier to amplify the microseismic resonance signals and a low pass filter to filter out high frequency microseismic resonance signal to generate amplified and filtered microseismic signal, a processor, and a memory storing instructions that, when executed by the processor, generates signal stacks from multiple measurements taken at single locations of the multiple surface locations. The some or all of the analog amplifier, the low pass filter, and/or the memory may be onboard the microseismic resonance detector and/or present on a remote computer or computer network connectable with the microseismic resonance detector. The system can be implemented to carry out any of the methods of detecting subsurface conditions conducive to fluid transfer described herein, and/or can be used in conjunction with gamma radiation detection and/or magnetometric density detection.

In further detail, water detection in particular can be carried out using one or both of microseismic resonance detection and/or gamma radiation detection. In some examples, assistance with detection of water may also include the use of magnetometric density. When combining detection technologies described herein, any two or three of these technologies can be carried out sequentially (in any order) and/or simultaneously. For example, gamma radiation detection may be used to obtain regions of interest and then microseismic resonance detection may be used to narrow down the areas where there may be water present or conditions for higher flow rates than the surrounding area. When two or three of these technologies point to the same or similar location, confidence levels for drilling may be increased, reducing the costs associated with drilling in areas where little to no subsurface water may actually be present.

In accordance with this, a method of detecting subsurface fluid within an area of interest can include obtaining microseismic resonance signals from multiple surface locations over a subsurface region of interest, and/or obtaining a gamma radiation count from multiple surface locations over the subsurface region of interest using a gamma radiation detector and identifying potential subsurface fluid locations where reduced gamma radiation count is present relative to background gamma radiation count. In some examples, the method can also include obtaining magnetometric density data based on a magnetic field generated by electric current passing through a hydrogeologic system of the subsurface region of interest. In other words, any two of the three of these methods/technologies can be combined to obtain better subsurface information for mapping. In some embodiments, all three methods can be used in detecting subsurface fluid with the area of interest. In some examples, obtaining the microseismic resonance signal is carried out and the microseismic resonance signal can be evaluated using frequencies at least as low as about 4 Hz to identify subsurface fracture zones where subsurface fluids may be present. In other examples, obtaining the gamma radiation count is carried out and the method can include determining the background radiation count over at least a portion of the subsurface region of interest and/or the gamma radiation detector can be equipped with an inorganic scintillation detector selected from a cesium halide crystal, cerium halide crystal, lanthanum halide crystal, or bismuth germinate crystal. In another example, the magnetometric density data can be used to create a model of the electric current distribution.

With the general examples set forth herein, it is noted in the present disclosure that when describing the methods, systems, or the related devices, individual or separate descriptions are considered applicable to one other, whether or not explicitly discussed in the context of a particular example or embodiment. For example, in discussing a microseismic resonance in the context of the methods, such examples are also related to any related systems and/or devices, and vice versa. Furthermore, terms used herein will have their ordinary meaning in the relevant technical field unless specified otherwise. In some instances, there are terms defined more specifically throughout the specification, with a few more general terms included at the end of the specification. These more specifically defined terms have the meaning as described herein.

Detection of Microseismic Resonance

Microseismic resonances can be detected using a device that approximates an earth stethoscope. Below the surface of the earth, geological resonances (or microseismic resonances) are generated at any of a number of subsurface discontinuities where there may be solid material boundaries, e.g., fractures, faults, joints, boulders, pebbles, rocks, etc., by natural phenomenon that may occur underground, e.g., natural expansion and contraction or earth tides causing the crust at fractures or other discontinuities to rub against one another. Moisture at these locations may contribute to the geological resonances that occur. For example, at areas where there are no fractures or discontinuities, and therefore very little or no passageways for fluids, there is little to no microseismic resonance signal that is detectable, which may be referred to as a dead zone.

In addition to cracks beneath the surface in hard rock matrix, porous earth (gravel and sand) also generate geological resonances as the earth crust expands and contracts. Other sources of geological resonances also contribute to the microseismic resonance that can be detected using a microseismic resonance detector as described herein.

In the resonance frequency spectrum, higher frequencies typically indicate microseismic resonances from sources nearer to the surface, whereas lower frequencies indicate microseismic resonances coming from deeper beneath the surface. Geological resonances, and thus microseismic resonance signals detected by the resonance sensor, typically indicate a source at a subsurface point below the sensor, at a depth proportional to the inverse of frequency measured.

As a general guide regarding sensing subsurface geological resonances, frequencies detected at various depths can range, as follows: from about 0.5 m to about 5 m, the frequency response may be from about 200 Hz to about 7,500 Hz; from about 5 m to about 20 m, the frequency response may be from about 50 Hz to about 1000 Hz; from about 20 m to about 100 m, the frequency response may be from about 10 Hz to about 250 Hz; from about 100 m to about 250 m, the frequency response may be from about 4 Hz to about 50 Hz; and from about 250 m and below, the frequency response may be from about 0.2 Hz to about 20 Hz. Note that these ranges overlap, as subsurface geological features and/or materials all have different seismic velocities, for example. Beneath the surface of a volume being measured for microseismic resonance signals, there may be solid materials that are hard and/or consolidated and solid materials that are soft and/or unconsolidated. The different types of materials resonate differently and can have a wide range of properties resulting in a wide range of seismic velocities. When there is mechanical contact between two solid materials that is weak, movement may be picked up as microseismic resonance signals with increased amplitude. The opposite is typically the case when there is stronger mechanical contact between two solid materials, which can generate microseismic resonance signals with decreased amplitude. However, there are exceptions. For example, open fracture systems are lacking the mechanical contact except at “hinge points” which are very high stress points. These various types of signals can be interpreted based on experience of the technician reading the collected data, for example. As there are typically subsurface regions or points of different types of material, weaker and/or stronger stresses involved with mechanical contact as reported by microseismic resonance signals amplitude at subsurface discontinuities, e.g., fractures, faults, boulders, pebbles, etc., and may provide additional information about the materials present and the likelihood of detecting subsurface conditions conducive to fluid transfer, which may lead to the discovery of water, oil, and/or gas, for example.

Furthermore, in addition to the frequency detectable as microseismic resonance signals, the velocity of seismic waves to surface for detection as microseismic resonance signal(s) can also assist with understanding the depth of geological resonances. Furthermore, signal stacking can be particularly useful in detecting and recording locations of microseismic resonance signals because subsurface geological matrices or systems are complex and can change fairly significantly over relatively short periods of time, e.g., a few seconds to a few hours. Thus, stacking and processing signals can generate more accurate results in many circumstances.

In accordance with this, methods of detecting subsurface conditions conducive to fluid transfer can include obtaining microseismic resonance signals from multiple surface locations over a subsurface region of interest using a resonance sensor, e.g., a piezoelectric sensor, wherein for at least a plurality of the multiple surface locations, multiple microseismic resonance signals are obtained at different times to generate signal stacks. This method can also include amplifying the microseismic resonance signals, filtering out the high frequencies at least above about 7,500 Hz leaving low frequencies at least as low as about 4 Hz for evaluation, and using these low frequencies to identify subsurface fracture zones where subsurface fluid may be present. In some examples, filtering out the high frequencies may include retaining all low frequencies below the high frequencies that are filtered out, e.g., everything below 7,500 Hz is kept.

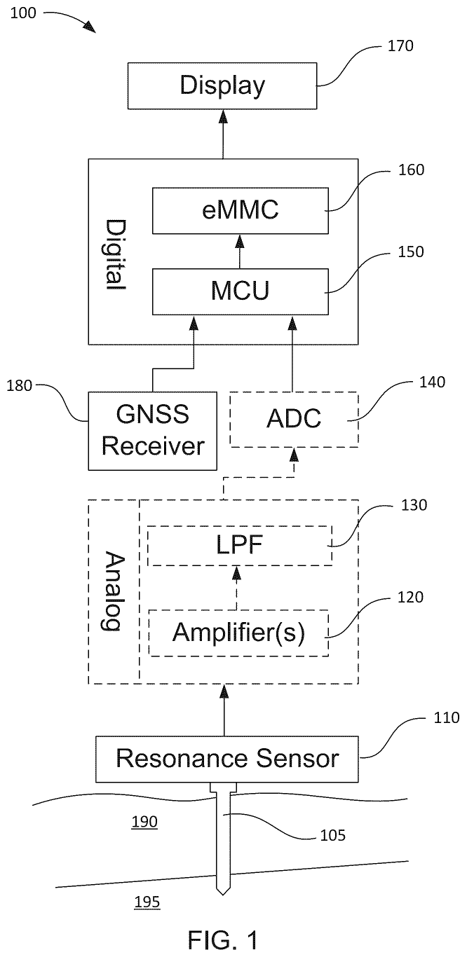

Detecting subsurface conditions conducive to fluid transfer can be carried out using a microseismic resonance detector 100, such as that shown by way of example at FIG. 1. Other arrangements may be used, as this arrangement is exemplary only.

Furthermore, boxes marked “digital” and “analog” do not infer that these components are on separate boards, nor does the presence of a component not shown as “digital” or “analog” infer it would or would not be present on a board. For example, any of these components may be integrated as part of a single unit or device, or may be any of a number of multiple components connected together by cable, electrical traces, wireless communication, etc. Thus, the term “microseismic resonance detector” may be in the form of a single device or may be in the form of a system of interconnected components in communication with one another.

As shown in the example microseismic resonance device 100, a resonance sensor 110 is shown in contact with a solid spike 105. The resonance sensor can include any sensor that can convert vibrational energy to electrical signal, such as a piezoelectric sensor, a spring-mounted wire coil/permanent magnet sensor, a microelectromechanical system (MEMS) sensor, or other similar resonance sensors. These sensors may respond in a manner that is proportional to ground velocity, acceleration, etc. In addition to the single location shown in this FIG., the spike can be driven through the multiple surface locations and into a subsurface region of interest at a depth ranging from at least about one inch to a depth where microseismic resonance emissions may be more reliably measurable. In this example, the solid spike is driven through loose sand 190 and into a resonant substrate 195, which is rock, clay, compacted dirt, etc. Alternatively, microseismic resonance signals detected using a piezoelectric or other sensor can occur, for example, by placing the sensor(s) directly on the multiple surface locations where microseismic resonance emissions are measurable. The resonance sensor may have a sensitivity suitable for sensing all or a representative number of frequencies spanning the range of about 4 Hz to about 800 Hz. In some examples, a resonance sensor(s), such as a piezoelectric sensor(s), can be used having a wider window of frequency response can alternatively be used, e.g., the ability to detect frequencies within the range of up to 7,500 Hz, e.g., from about 0.5 Hz to about 7,500 Hz.

If a piezoelectric material is used for the resonance sensor 110, this can include material any sensitive enough to detect subsurface geologic resonance within the frequency ranges of interest. Piezoelectric materials can be inorganic piezoelectric materials or organic piezoelectric materials. More specifically, the piezoelectric material may include a piezoelectric polycrystal or piezoelectric ceramics, with examples including barium titanate or lead zirconate titanate. In particular, piezoelectric polycrystals possess piezoelectric property with a high dielectric constant making them suitable for high power transducers. Having this property makes these materials effective for use in monitoring and/or detecting geologic resonance sufficient to collect microseismic resonance signals. Furthermore, by way of example, piezoelectric ceramics and/or PVDF piezoelectric can likewise be used, among others. For example, the piezoelectric material can be any of a number of compounds, but zirconate titanate (PZT) works considerably well. Furthermore, even though PVDF piezoelectric films have been understood in the past to be less effective for detecting seismic waves than piezoelectric crystals and/or ceramics, it has been recognized that PVDF may provide good sensitivity in certain circumstances, and furthermore, are not as brittle or a material as ceramic, and is not as prone to cracking. In further detail, piezoelectric sensors may include the piezoelectric material as described above by example, and may include any of a number of vibration pick-up structures, such as cantilever beams, coil springs, elastic films, etc., which are configured for rapid deformation.

As the resonance sensor 110 picks up microseismic resonance signals from subsurface geologic resonances (through the solid spike in this instance), the electrical signal generated from the resonance sensor in some examples (as illustrated by the presence of phantom lines) can be relayed to an amplifier 120, or multiple amplifiers, a low pass filter (LPF) 130, and an analog/digital converter (ADC) 140. In some examples, the analog amplifier and the low pass filter may be beneficial, depending on the circumstances. When used, as shown in this particular example, the amplifier could be a programmable instrumentation dual stage amplifier with two amplifiers connected in series, each capable of generating up to 8:1 gain. The amplifier in this example is an analog amplifier, as analog amplification can provide better resolution, particularly when amplifying at 16:1 gain, 32:1 gain, or 64:1 gain. To illustrate, if a single-stage amplifier can amplify microseismic resonance signals at 2:1 gain, 4:1 gain, or 8:1 gain, then a 2-stage amplifier could amplify the same signal at 16:1 gain, 32:1 gain, or 64:1 gain, for example.

The analog amplified signal can then be filtered to remove unnecessary or unusable high frequencies, for example, using a low pass filter 130. The low pass filter can be selected to remove frequencies above about 800 Hz, 2,000 Hz, 4,000 Hz, 6,000 Hz, or 7,500 Hz, or any other frequency that would provide a benefit for a specification application. Typically, filtering out frequencies above about 7,500 Hz is sufficient, but more filtration can be used if desired for excluding geologic resonances closer to the surface. In other words, the microseismic resonance signals can be filtered to remove signals outside of useful ranges for detecting subsurface conditions conducive to fluid transfer for the fluid depth being targeted. A lower threshold of high frequencies could be filtered out for use in discovery of very deep oil and/or gas, for example. Microseismic resonance signal filtration can be carried out using any of a number of filters, such as a maximally flat magnitude filter, e.g., a Butterworth filter, a Bessel filter, or a Chebyshev filter. The Butterworth filter, for example, may be a 5^{th} Order 7.5 kHz Butterworth Low

Pass Filter, but any of a number of low pass filters can be used to filter out unneeded higher frequencies in many circumstances. In further detail, amplifying the microseismic resonance signals and/or filtering out the high frequencies can be carried out as analog signals to obtain the low frequencies and the low frequencies can be converted to a digital signal for digital processing, for example. In some examples, at least some of the digital processing may occur onboard a microseismic resonance detector. In other examples, at least some of the digital processing can occur remotely after transfer to a computer or a network.

In further detail, the microseismic resonance device 100 can be configured to covert the amplified and filtered microseismic resonance signal to a digital signal using an analog/digital converter 140. An example analog digital converter that is suitable for use is a 16-bit 200 ksps analog/digital converter.

The now digital microseismic resonance signal (from the analog/digital converter 140) may be combined in a single data file, for example, with data collected from a global navigation Satellite System (GNSS) receiver 180, such as a uBlox ZED-F9P multi-band GNSS receiver or other suitable GNSS receiver. Example GNSS receivers may include receivers suitable for receiving signals based on GPS, GLONASS, Galileo, BeiDou, and QZSS, etc., and/or cellular systems based on GSM-, UMTS-, 3G, LTE, 4G, 5G, etc. Others can likewise be used. In some examples, the onboard location data collected on the microseismic resonance detector may be collected using an onboard receiver adapted to receive RF signal from a terrestrial base station source and a second reference signal. For example, the microseismic resonance detector may include an on-board receiver adapted for real-time kinematic positioning. The use of more local RF signal from a terrestrial base can be used, for example, when much more highly accurate fluid detection would be useful, e.g., smaller areas with readings taken closer together. In further detail, the microseismic resonance signal can be obtained onboard a microseismic resonance detector which also collects onboard location data in some examples. This can be particularly useful when collecting subsurface data on large areas. The data file can be generated, and in some instances further processed, on a processor, such as a microcomputer unit 150 (MCU). The MCU may be enabled with WiFi and/or Bluetooth, for example. In some examples, the MCU may pass the digital signal to an embedded multimedia card 160, such as an eMMC Flash device for later upload to a computer or computer network, for example. Alternatively, the device may likewise be enabled for transferring data by wireless communication to a computer or computer network on-site or over a cellular network, for example. A display 170 may be included, which may be a digital display such as a smartphone display, tablet display, computer display, an electronic paper display (e-ink or intelligent paper), etc.

In further detail, when collecting microseismic resonance signals, individual locations can be established for collecting signal stacks to be processed for the generation of modified microseismic resonance signals that represents the multiple microseismic resonance signals collected at a single location. The signal stacks can be processed, for example, as mean microseismic resonance signals, arithmetic mean microseismic resonance signals, geometric mean microseismic resonance signals, median microseismic resonance signals, mid-point microseismic resonance signals, microseismic resonance signals with outlier signals filtered out, or a combination thereof. The signal stacks can be based on any of a number of multiple readings, but typically the signal stacks can be based on 2 to 10 sequentially obtained microseismic resonance signals. The spacing between signals can be negligible, e.g., from about 0 to about 1 second, or can be longer in time, multiple seconds to days or longer. The 2 to 10 individually obtained microseismic resonance signals can be obtained within about 15 minutes, within about 10 minutes, within about 5 minutes, within about 1 minute, etc., depending on how deep the signals are coming from beneath the surface. Deeper microseismic resonance signals may be particularly useful when exploring for oil and/or gas, e.g., methane, natural gas, etc. When discovering the location of subsurface water, shallower microseismic resonance signals may be more relevant and would thus typically take less time in obtaining microseismic resonance signals of each signal stack.

In further detail, particularly for the detection of water as the subsurface fluid, the methods herein can also include identifying the possibility of subsurface water using a gamma radiation detector where there is a reduced gamma radiation count relative to a background gamma radiation count. In other examples, identifying or confirming the possibility of subsurface water to be used in conjunction with the detection of microseismic resonance can include using magnetometric density.

### Detection of Gamma Radiation

In search of water for purposes such as digging wells, injecting recharge, remediating contamination transport, etc., underground water can reside from a few feet to many hundreds of feet below the earth surface. As a result, the detection of gamma radiation would seem to not be useful in locating subsurface water. More specifically, gamma radiation can typically only be detected at the surface of the earth down to about 2 feet below the surface. As mentioned, discovery of water is usually much deeper than this. As water tends to block gamma radiation, the presence of water at or very near the surface of the earth tends to typically reduce gamma radiation emissions that are detectable using a gamma radiation detector. After considerable field work, it has been discovered that above subsurface water that may be much deeper than about 2 feet, a reduction in gamma radiation may be noted. Without being bound by any particular theory, the partial blocking or reduction of gamma radiation above underground water may be the result of water vapor venting and escaping through the earth surface and into the atmosphere. Thus, often above underground water, a measurable gamma radiation reduction can be measured relative to background gamma radiation at other nearby locations. Gamma detectors are typically used for detecting minerals, so gamma radiation detection for the discovery of water is not the way these systems are normally used.

However, when water vapor vents through the shallow subsurface of the earth, it may also alter the chemistry of soil, which is what gamma radiation detectors do well. Using a gamma radiation detector for the discovery of water is more of an indirect method of detection than the discovery of minerals.

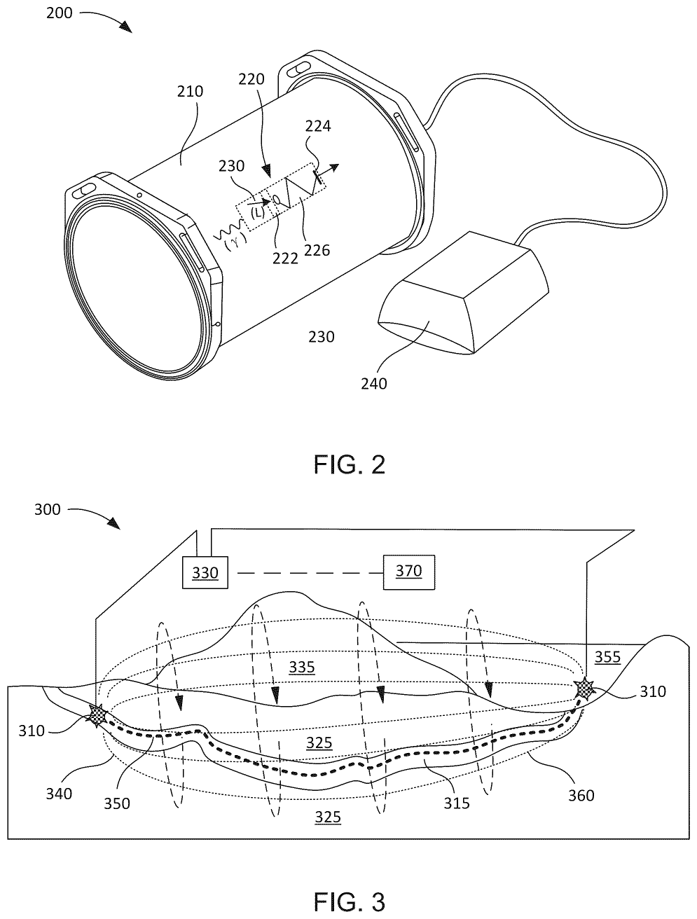

An example gamma radiation detector 200 is shown in FIG. 2, which includes a magnetically shielded housing 210 carrying an inorganic scintillation detector 220. An example scintillation detector is shown, but could be arranged differently. Essentially, as gamma (Y) radiation is emitted and picked up by a scintillating crystal 230, such as a cesium halide crystal, cerium halide crystal, lanthanum halide crystal, or bismuth germinate crystal, light (L) is emitted from the crystal into a photomultiplier tube 226.

The photomultiplier tube is positioned between a photocathode 222 and an anode 224. A measuring device may be included to receive the light signal generated by the scintillating crystal and multiplied by the photomultiplier. In this example, also shown is a connection box 240, and furthermore, there may also be a GNSS (or GPS) antenna for collecting location data to associate with the gamma radiation readings.

In accordance with this, a method of detecting subsurface water or conditions conducive to subsurface water can include obtaining a gamma radiation count from multiple surface locations over a subsurface region of interest. Example gamma radiation detectors that can be used include those with an inorganic scintillation detector selected from a cesium halide crystal, cerium halide crystal, lanthanum halide crystal, or bismuth germinate crystal, for example. For more specific non-limiting examples, the cesium halide crystal may be in the form of a cesium iodide crystal, the cerium halide crystal may be in the form of a cerium bromide crystal, and the lanthanum halide crystal may be in the form of a lanthanum bromide crystal. The halide crystal selected may likewise be the other of the iodide or bromide crystals mentioned above, for example. Others can likewise be used, particularly in combination with the methods herein for detecting microseismic resonance. However, these particular inorganic scintillation detectors are particularly effective and accurate when looking for underground water. The method can likewise include determining a background gamma radiation count over at least a portion of the subsurface region of interest, and also identifying a potential subsurface water location within the region of interest where a reduced gamma radiation count is present relative to the background gamma radiation count. In additional detail, the inorganic scintillation detectors of the present disclosure may be doped with thallium or cerium. For example, a cesium iodide crystal may be doped with thallium or cerium. A cerium bromide crystal may be doped with thallium, a lanthanum iodide crystal may be doped with thallium or cerium. A bismuth germinate crystal may be doped with thallium or cerium. Other dopants may likewise be used.

To provide some additional detail regarding a few of the inorganic scintillation detectors that can be selected for use, crystal electronics may be associated with a silicon photomultiplier, such as a multi-piece SiPM structure. The crystal itself may have a footprint greater than about 4 square inches, greater than about 6 square inches, or greater than about 8 square inches. For example, a cesium iodide crystal and/or a cerium iodide crystal may be three inches by three inches in size, both of which are available for inclusion in the Medusa Radiometrics MS-350 gamma radiation detector. A cesium iodide crystal may have a density of about 4.3 kg/L to about 4.7 kg/L, an energy resolution typically above about 8.5% on ¹³⁷Cs (661 keV), and may be very robust for long term rugged operation. A cerium bromide crystal may have a density from about 4.9 kg/L to about 5.3 kg/L, an energy resolution typically better than about 3.9% ¹³⁷Cs (661 keV), and may be more suitable when peak analysis and/or higher resolution would be useful.

When collecting gamma radiation data using a gamma radiation detector for the purpose of identifying the possibility of subsurface water, reduced gamma radiation counts can be from about 5% to 100% less than the background gamma radiation count, which is a significant enough difference to note the possibility of underground water. More typically, the reduced gamma radiation count will be from about 10% to about 75% less than the background gamma radiation count. In additional detail, the background gamma radiation count may be from about 20 counts per second to about 500 counts per second, and the reduced gamma radiation count can be from 5 counts per second to 75 counts per second lower than the background gamma radiation count.

Obtaining gamma radiation counts can occur, for example, as the gamma radiation detector is moving over the subsurface region of interest. Typically, the closer that the gamma radiation detector is to the surface that is emitting gamma radiation, the better the resolutions are that can be obtained. However, at less than 10 feet or less above the surface (above the subsurface locations of interest), the resolution can be very good, and even at 100 feet or less above the surface, the gamma radiation detection can be sufficiently acceptable to potentially identify the location of underground water. As the elevation increases, the count rate of the gamma radiation goes down fairly quickly. For example, at the surface or even at about five (5) feet in elevation, the count rate may be more than double the count rate at 100 feet.

As an example of techniques of gamma radiation detection, a technician may include the gamma radiation detector in or on a backpack for carrying around a land area of interest. Alternatively, the gamma radiation detector could likewise be associated with a remote drone at higher altitudes to travel the area of interest to detect water using gamma radiation. The gamma radiation detector, regardless of how it traverses the area of interest, may be done so in a pattern, such as a serpentine pattern, a spiral pattern, a straight line, or other pattern suitable for the terrain. When doing a serpentine pattern using a backpack, a suitable distance between rows walked or otherwise traversed, e.g., using a vehicle, may be from about 5 feet to about 200 feet apart, or from about 10 feet to about 150 feet apart, for example, though even tighter or larger patterns may be used as may be determined based on the technician's knowledge of the terrain.

In additional detail, the gamma radiation detector counts may be processed using Gaussian smoothing averages using a window period of some establish amount of time, such as from about 1 to 20 seconds, about 2 to 15 seconds, about 2 to 10 seconds, about 4 to 15 seconds, etc. etc. Whatever time increment is used, the gamma radiation data can be collated together, e.g., averaged, depending on the background conditions and degree of fluctuations.

The gamma radiation detector can also simultaneously collect onboard location data for at least a portion of the time increments. As with the microseismic resonance detectors described previously, location data may be collected using a global navigation Satellite System (GNSS) receiver 180, such as the uBlox ZED-F9P multi-band GNSS receiver or other suitable GNSS receiver. Other example GNSS receivers may include receivers suitable for receiving signal based on GPS, GLONASS, Galileo, BeiDou, and QZSS, etc., among others, and/or cellular systems based on GSM-, UMTS-, 3G, LTE, 4G, 5G, etc., among others. In some examples, the onboard location data collected by the gamma radiation detector may be collected using an onboard receiver adapted to receive RF signals from a terrestrial base station source and a second reference signal. An onboard GNSS receiver may optionally be included as well for obtaining reference signals, for example. More specifically, the gamma radiation detector may include an onboard receiver adapted for real-time kinematic positioning. The use of more local RF signals from a terrestrial base can be used, for example, when much more highly accurate water location data would be useful, e.g., smaller areas with readings taken closer together. In some examples, the gamma radiation detector can generate gamma radiation data that can be combined with location data collected from one or more of the onboard receivers such that the gamma radiation data and the location data are combined as a common file.

The data collected may be stored onboard the gamma radiation detector or may be broadcast wirelessly to a computer or computer network using any of a number of wireless technologies, including WiFi, Bluetooth, a cellular system, etc. In some examples, the gamma radiation data may be collected as a raw multichannel gamma-ray spectra, an energy-stabilized gamma-ray spectra, and as mentioned, may be combined with a complete location record as a common combined filed. In some examples, the location data may be kept separate but may be otherwise correlated using software or firmware, for example. The location record may include latitude data, longitude data, elevation data (distance above the surface), DOP error data, satellite(s) used, position quality, pressure, temperature, humidity, etc.

In additional detail, water location may further include identifying the possibility of subsurface water using a microseismic resonance detector as previously described as a validation after gamma radiation detection or to narrow down locations for gamma ray detection. The microseismic resonance can be used to detect subsurface discontinuities, e.g., fracture zones, etc., where subsurface water may be present. Typically, gamma ray detection may be carried out first to get an idea of the location of water and then microseismic resonance detection may occur to generate additional resolution, but the reverse order could likewise occur. Simultaneous detection can also be used in some instances. In still other examples, locating water may additionally or alternatively include identifying the possibility of subsurface water using magnetometric density.

### Detection of Magnetometric Density

Magnetometric density (MMD) is a technology approach for detecting subsurface water that uses multiple electrodes separated from one another and positioned in electrical communication with a body of subsurface water in order to detect, e.g., map, discover, monitor, etc., the location of the water. “Magnetometric density” is interpreted through the Biot Savart Law on the basis of electric current density, and is akin to magnetometric resistivity (MMR). However, in some examples, the magnetometric approach used to detect water may or may not be interpreted by the more classical “resistivity” equations. For example, electromagnetic signal collected using this magnetometric density approach can be converted using an inversion model, which is referred to herein as electric current density (ECD), or ECD model.

With magnetometric density, a current source is used to generate a current between the electrodes through the subsurface body of water, and an ammeter may then be used to detect current, which provides information about the water content between and around the electrodes. The two electrodes can be stationary, or in some more specific examples, one of the electrodes can move through a body of water while the other remains stationary.

In a more specific example, a geophysical method of using electromagnetic energy for detecting subsurface water, e.g. water beneath the surface of the earth or other large water-containing structure or system, may include any of a number of methodologies, both in terms of data collections and interpretation of data. Some of these steps or the order of these steps may not be required, but an example list of methodologies is provided in detail so that the process may be better understood. For example, this geophysical method using magnetometric density may include introducing an electrical current into a water-containing system to electrically energize the water therein, and monitoring multiple surface locations where the subsurface water may be located to measure magnetic and/or electric fields produced by the electrical current passing through the subsurface water. The measured electric and/or magnetic fields are interpreted by a technician who understands how the technology works. Example considerations used for interpretation of the data include correcting for diurnals, current drift of the transmitter, and any base intensity changes; determining a path of the water from minimum horizontal magnetic field direction or from perpendicular to maximum horizontal magnetic field; determining direction of electric current flow in the water from direction of maximum surface electrical field potential or alternatively from direction perpendicular to minimum surface electric field potential; and/or determining the width of the subsurface water from rate of change of vertical magnetic field intensity across an anomaly. Other considerations for interpretation may include estimating depth and width of the subsurface aqueous channel from width of the measured horizontal magnetic field;

resolving ambiguities of channel width and depth of the subsurface water using anomaly slope and anomaly width of vertical and horizontal magnetic field data; determining depth of the subsurface water by correlating said electric and magnetic fields; determining conductivity of the subsurface water from the measured electric field, and the measured magnetic field; and/or determining chemical or biological activity from localized intensity increases measured in either magnetic or electric fields. The technician may also compare changes in the various components of magnetic and electric fields over time to provide information relating to fluid movement, change in chemical activity, changes of fluid in an aquifer, changes in subsurface biological activity, movement of chemical or bio-reaction fronts, leaching progress and activity relating to in situ mining, progress of subsurface chemical or biological remediation, increases or decrease in subsurface flow, changes in salinity, or any change in the groundwater that affects any of its electrical properties. Other considerations may include mathematically normalizing electromagnetic field intensity readings for distance from the energizing electrode; evaluating electrical contrast between the channel and host rock by observing rate at which the measured magnetic and electric fields degrade; relating depth and dispersion of the ground current to the gradient of the magnetic field; relating subsurface reaction zones to crossed electric and magnetic field gradients; plotting data in profile form; and/or plotting data as a contour map. Still other considerations may include taking account of a subsurface attached clay lens, such as a repository lining, which tends to mask the field of the conductor being tracked and could produce localized high readings in wet areas as said clay lens will act as a good conductor and concentrate current; conducting periodic surveys or sets of measurements over time, to show changes in field values which are plotted by taking the difference or ratio of measurement readings; conducting a baseline reference survey when using this method to monitor activity such as movement, chemistry changes, or bioactivity over a period of time; and/or constructing a model of the electrical current flow in the subsurface water from the measured magnetic and electric fields.

FIG. 3 illustrates a magnetometric density (MMD) system 300 as may be set up at an example region of land and water. This magnetometric density system or a similarly configured system may be used in combination with a microseismic resonance detector and/or a gamma radiation detector in accordance with the present disclosure for detecting subsurface fluids, e.g., water. This example illustrates an essentially horizontal dipole arrangement, but alternative setups may likewise be used. For example, a vertical dipole arrangement could be used where one electrode is at or close to the surface and a second electrode is placed beneath the surface, e.g., from about 5 feet to about 2,000 feet in depth. The principles associated with the operation of a vertical dipole arrangement would be similar, except that the electric current flow lines and the magnetic fields shown in FIG. 3 would be rotated by about 90 degree in the x-y direction compared to that which is shown.

As an example, this magnetometric density system 300 includes an upstream electrode 310, a downstream electrode 320, and a power supply 330 connected electrically by antenna wire in this example. As shown, electric current flow lines 340 are approximated that may be present between the two electrodes, and are shown as dotted lines. One of the electric current flow lines is found flowing through a subsurface water channel 315, which is referred to as a subsurface water electric current path 350. The groundwater electric current path provides electrical communication between electrodes through the subsurface water channel. In this instance, the subsurface water channel exemplified is groundwater seepage defined primarily by foundation rock 325. An example approximation of the possible magnetic field 360 is also shown schematically, which is illustrated as magnetic flux in accordance with the right-hand-rule. A mound of random fill 335 is also shown as being present on top of the foundation rock along with a body of water 355, which in this instance is a small pond.

In operation, the power supply 330 is connected to the upstream electrode 310 and the downstream electrode 320. The subsurface water electric current path 350 passes between electrodes and returns to the power supply 330, completing an electric loop. In addition to the power supply, the electrical circuit typically includes instruments 370 for measuring the voltage and/or current injected into the system, and in some examples, provides the frequency if alternating current is used to stimulate the subsurface water.

Example instruments used for measurement may include a voltmeter, ammeter, signal analyzer, etc. A technician with understanding of this technology can then read the instruments to provide information about the subsurface water that may be present.

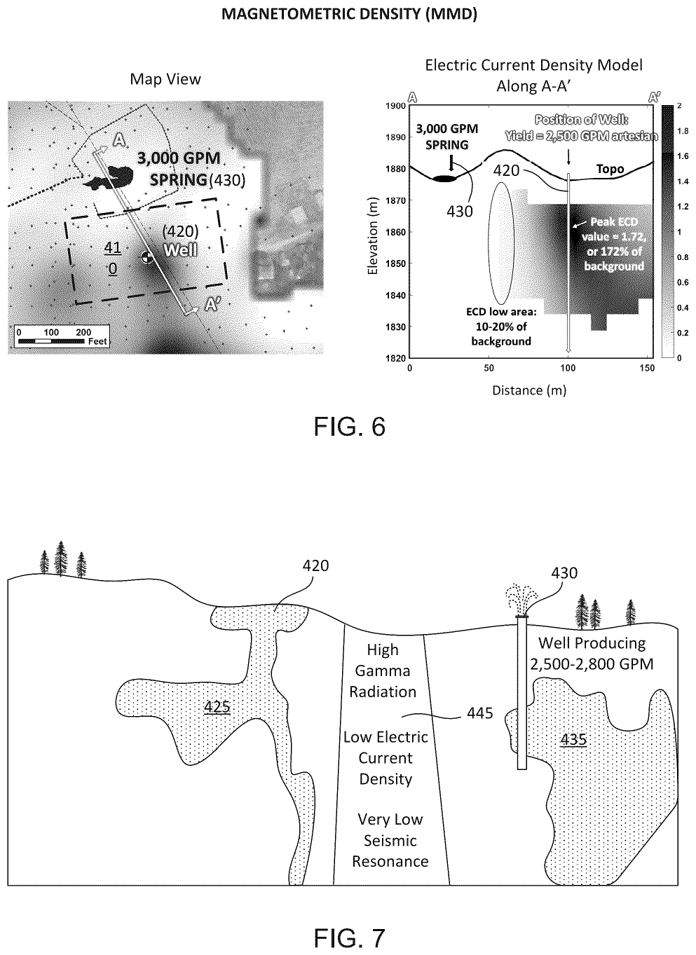

With the electromagnetic field in place across the area being measured (between the two electrodes having a shape similar to that shown in FIG. 3), a technician may move from location to location over an area within the magnetic field to take measurements using a magnetic field measuring instrument, such the instrument used for the Willowstick method, at multiple locations at many locations. Where there is an electric current passing through the underground water, an associated magnetic field will also be present that can be measured using such an instrument. The magnetic field measuring instrument may include, for example, multiple coils adapted to measure the X-component of magnetic field, the Y-component of magnetic field, and the Z-component of magnetic field. By mapping the magnetic field, a subsurface water electric current path may be detectable. Sample locations where measurements may be taken over an area of land is shown by example in FIG. 6 using small plus (+) symbols. At these locations, a GPS antenna may collect location data at each measurement site. In further detail, magnetometric density technology can leverage the use of magnetic field and/or electric current produced by a precisely controlled electrical current introduced into subsurface water. The electric current can flow in the groundwater conductor, creating a magnetic field around the conductor, which is the groundwater. By monitoring the magnetic field, the path of the groundwater can be detected from the surface. The anomalous changes that occur in the magnetic field and how the field varies with time can be used to map and monitor activity such as seasonal fluctuations, pumping, in situ leaching, and chemical or biological reactions that are taking place in subsurface solutions. These properties may be measured using surface readings, for example. In additional detail, magnetometric density technology can be used to directly energize the target horizon where there may be a confirmation that the signal being measured is coming from the designated or desired target.

To demonstrate by example how the present technology operates, as electric current flows in a wire, a magnetic field is produced that circles the wire via the right-hand-rule. If a conductive subsurface body of water provides the electrical connection between electrodes instead of a wire, electric and magnetic fields form directly above the water channel. The magnetic field in this instance may be essentially horizontal and perpendicular to the conducting zone just as it would be for a wire connection. This may also be true for a curved conductor, where the strongest field strength will be measured directly over the conductor. If measured, the magnetic field traces a path on the surface that follows the path of the conductor, which in this system is the subsurface water channel. Additional detail regarding how this technology works can be found in U.S. Pat. Nos. 5,825,188, 8,688,423, and 9,588,247, as well as U.S. Patent Application No. US 2012/0139542A1, each of which is incorporated herein by reference.

### Computing Systems and Devices

The devices, systems, can methods described herein can utilize any of a number of computing devices and/or systems. Any of the computing devices or systems shown or described herein can include a single computing device, multiple computing devices, a cluster of computing devices, or the like. A computing device can include one or more physical processors communicatively coupled to memory devices, input/output devices, or the like. As used herein, a central processing unit (CPU), a microcomputer unit, or the like may be referred to here as a “processor.”

Additionally, as used herein, a processor can include one or more devices capable of executing instructions encoding arithmetic, logical, and/or I/O operations. In one illustrative example, a processor may implement a Von Neumann architectural model and may include an arithmetic logic unit (ALU), a control unit, and/or a plurality of registers. In some aspects, a processor may be a single core processor that is typically capable of executing one instruction at a time (or process a single pipeline of instructions) and/or a multi-core processor that may simultaneously execute multiple instructions. In some examples, a processor may be implemented as a single integrated circuit, two or more integrated circuits, and/or may be a component of a multi-chip module in which individual microprocessor dies are included in a single integrated circuit package and hence share a single socket. As described herein, a memory refers to a volatile or non-volatile memory device, such as RAM, ROM, EEPROM, or any other device capable of storing data. Input/output devices can include a network device (e.g., a network adapter or any other component that connects a computer to a computer network), a peripheral component interconnect (PCI) device, storage devices, disk drives, sound or video adaptors, photo/video cameras, printer devices, keyboards, displays, etc. In some aspects, a computing device provides an interface, such as an API or web service, which provides some or all of the data to other computing devices for further processing. Access to the interface can be open and/or secured using any of a variety of techniques, such as by using client authorization keys, as appropriate to the requirements of specific applications of the disclosure.

When a network is used, the network can include a LAN (local area network), a WAN (wide area network), telephone network (e.g., Public Switched Telephone Network (PSTN)), Session Initiation Protocol (SIP) network, wireless network, point-to-point network, star network, token ring network, hub network, wireless networks (including protocols such as EDGE, 3G, 4G LTE, Wi-Fi, 5G, WiMAX, and the like), the Internet, or the like. A variety of authorization and authentication techniques, such as username/password, Open Authorization (OAuth), Kerberos, SecureID, digital certificates, and more, may be used to secure the communications.

### EXAMPLES

The following examples illustrate embodiments of the present disclosure. However, it is to be understood that these examples are merely illustrative of the application of the principles of the present disclosure. Numerous modifications and alternative compositions, methods, and systems may be devised without departing from the scope of the present disclosure.

### Example 1—Microseismic Resonance Signal Measurements

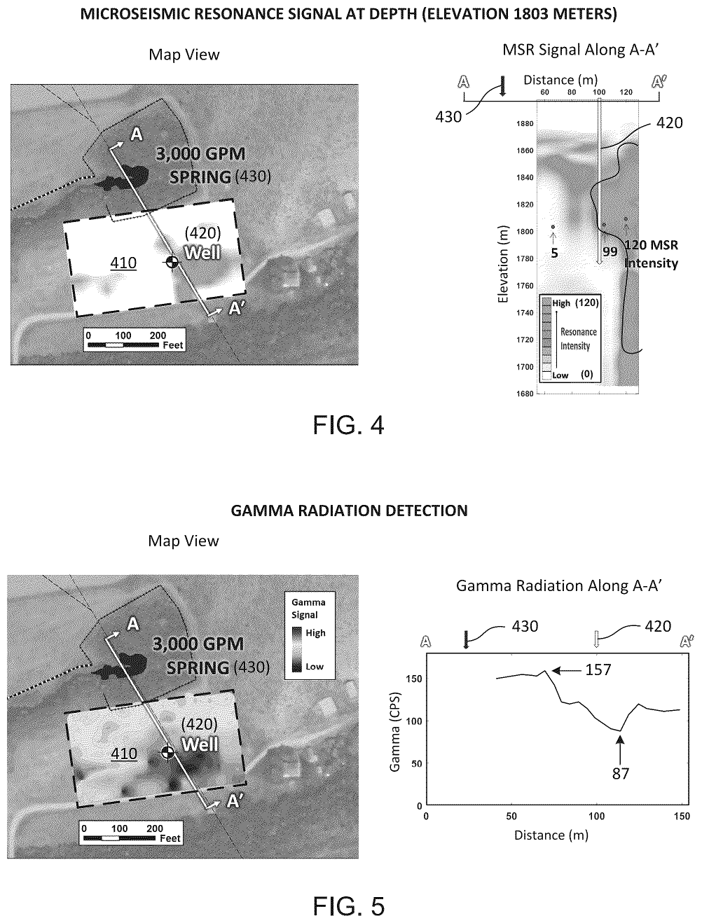

As shown in FIG. 4, microseismic resonance (MSR) signals were collected across an area of interest 410 of a plot of land that included a well 420 which was recently dug prior to this MSR analysis. The microseismic resonance signals were converted to data for mapping. Notably, the surrounding land also included a spring 430, which was outside of the area of interest for this evaluation. As can be seen in a portion of the microseismic resonance signal data collected, the microseismic resonance intensity values collected include three (3) specific data points, each at about 100 meters in depth. At one subsurface location, an intensity of 5 was measured, indicating limited water or the ability of water to move. At two other subsurface locations, the intensities were measured at 99 and 120, respectively. These higher intensities would indicate a higher probability of subsurface water being present and able to move through the space. Based on the microseismic resonance signals and associated data within the area of interest, it was found that the pre-existing well was positioned near the edge of a large underground anomalous zone, as seen to the right of the location of the bottom of the well pipe.

### Example 2—Gamma Radiation Measurements

The same area of interest 410 that was studied in Example 1 was also the location where gamma radiation measurements were taken, as shown in FIG. 5. Again, this area of interest already had a pre-dug well 420 and a spring also on the land at a region just outside of the area of interest. Using a gamma radiation detector, low relative gamma radiation values (80-99 counts per second, or CPS) were observed around the well location, with considerably higher relative gamma radiation values (150+CPS) being located between the spring and the well. In this example, the location where the higher gamma radiation was found could be considered background signal. Thus, the lower gamma radiation count ranged from about 50 to 80 counts lower than the adjacent region where the higher relative gamma radiation count was obtained. The lower gamma radiation count would indicate the likelihood that water would be below the surface, including water that is much deeper than the 18 inches to 2 feet that a gamma radiation detector is capable of detecting. Nonetheless, it may be that water vapor venting above the underground water reservoir and out into the atmosphere may act to lower the gamma radiation emissions near the surface due to the presence of the water content and/or due to the chemistry of the top two feet of earth which may have been altered due to water vapor venting sourced well below the surface.

### Example 3—Magnetometric Density Measurements

An area of land shown in FIG. 6 (including areas outside of the area of interest 410) were evaluated using magnetometric density (MMD). In this example, the electrodes were placed in the spring (430) and in a far-away location in contact with groundwater. More specifically, magnetometric density measurements in this example were converted to electric current density (ECD) using an inversion model. The data collected was normalized such that the unitless value of “1” indicated background signal from a homogeneous earth model. The higher values, e.g., with a peak value of 172% of background signal, were found over a large anomalous zone immediately adjacent to where the well was drilled. The lower values, e.g., from 10-20% of background were found between the spring and the well.

### Example 4—Combination of Technologies and Estimated Success Rate Encountering Subsurface Water

In looking at the technical analysis of particular plot of land, and in particular the area of interest, it is clear that each of these three technologies can be used in concert to enhance the details of what is understood to be going on beneath the surface with respect to fluids, e.g., water in this instance. For example, the microseismic resonance data collected in Example 1 can be considered as indicating significant conducive conditions for water starting at about 50 meters below the surface of the area of interest along section A-A′, as shown. The gamma radiation detection of Example 2 can be used together with microseismic resonance detection to gather information to provide a more complete picture of what may be present beneath the surface of the earth. To illustrate, a technician may use gamma radiation to discover areas of likely water vapor venting and use that surface map to conduct microseismic resonance detection to gather confirmatory information regarding a surface location to dig a well, with added information regarding how deep well will need to be to reach water. The reverse order could likewise be used. Still further, additional confirmatory location and depth data can be generated by using magnetometric density, as described in Example 3.

Notably, any two or even all three of these methodologies can be used to detect subsurface fluid, such as water in this instance. In this case, only the MMD technology was used to identify where to dig the well, but as can be seen from the data collected using one or both of the other two technologies, additional information would have been available in deciding the best place to dig the well. Though the other two were conducted after the well was already in place, this technology could likewise be used before digging the well to discover a good location for water discovery.

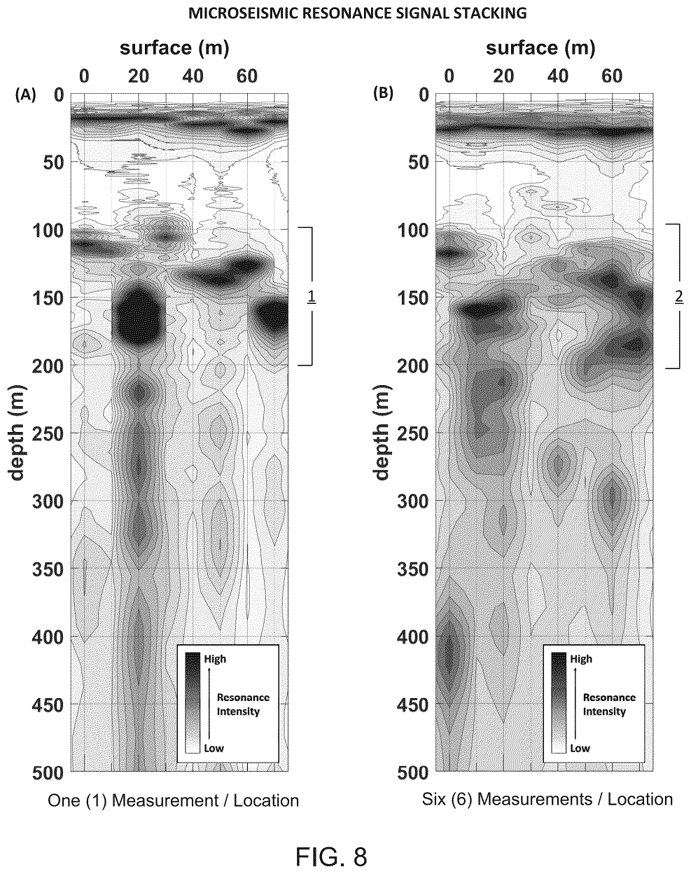

To provide additional detail regarding the use of multiple technologies together, an underground cross-sectional schematic approximating what the subsurface region shown in FIGS. 4-6 is shown at FIG. 7. This schematic diagram is not intended to be accurate, but rather show what may be going on in a representative way beneath the surface in order to gain an even greater understanding of the subsurface fluids. For example, when using microseismic resonance to detect subsurface conditions conducive to fluid transfer, e.g. water, oil, and or gas discovery, multiple microseismic resonance signals can be collected from various individual locations. As shown, a well 420 and a spring 430 are present. It is noted that prior to the well being dug, the spring was producing 3000 gallons of water per minute (GPM). After the well was dug, the well produced 2,500 to 2,800 GPM without the use of a pump, making it an artesian well. This would indicated that the subsurface water from the well was under high pressure prior to being tapped. Furthermore, it is believed that between the spring water source 425 and the water well source 435 that there is a relatively impervious wall of earth material 445, e.g., solid rock or other earth barrier conditions that are preventing these two sources of water from being part of the same subsurface water system. This is surmised because when the well began producing 2,500 to 2,800 GPM, the production of the spring remained unaffected at 3,000 GPM. Furthermore, the measurements taken by the microseismic resonance device, the gamma radiation detector, and the magnetometric density equipment confirmed this assumption. For example, in the region between the two bodies of water, the various instruments indicated very low seismic resonance, high gamma radiation, and low electric current density. As a practical matter after conducting many land evaluations, using just gamma radiation and microseismic resonance detection techniques, a success rate of finding water beneath the surface has been from about 85% to about 90% to date.

### Example 5—Microseismic Resonance Signal Stacking

Microseismic resonance (MSR) detection can be a good tool for understanding what is happening beneath the surface of an area of land. However, an increase in resolution using microseismic resonance can be obtained by generating multiple signal stacks at individual locations along the surface. As shown in FIG. 8, a subsurface volume was evaluated with microseismic resonance detection and two 2D slices are shown through the subsurface volume at the same cross-section. A single measurement was taken at each location along the surface above the cross-section area based on a single measurement compared to the use of signal stacking. More specifically, a single measurement was taken every 10 meters along the surface in a straight line and the collected resonance signal was mapped as shown at subsurface map (A). Conversely, the same locations were measured over the same region of land, but at each location, six (6) different measurements were taken. Subsurface map (B) utilized this signal stacking methodology. As can be seen by comparing subsurface maps (A) and (B), much more information is provided when multiple measurements are taken at a single location with the signal data stacked and then compiled, e.g., averaged or some other aggregating methodology. In looking particularly at Region “1” compared to Region “2,” much more detail regarding water content is available. For example, where six (6) measurements were taken at each location and averaged, more clarity of high resonance intensity anomalies is noted.

While the present technology has been described with reference to certain examples, it will be appreciated that various modifications, changes, omissions, and substitutions can be made without departing from the spirit of the disclosure. It is intended, therefore, that the disclosure be limited only by the scope of the following claims.

1. A method of detecting subsurface conditions conducive to fluid transfer, comprising:
obtaining microseismic resonance signals from multiple surface locations over a subsurface region of interest using a resonance sensor, wherein for at least a plurality of the multiple surface locations, multiple microseismic resonance signals are obtained at different times to generate signal stacks;
amplifying the microseismic resonance signals;
filtering out the high frequencies at least above about 7,500 Hz leaving low frequencies at least as low as about 4 Hz for evaluation;
using the low frequencies, identifying subsurface fracture zones where subsurface fluid may be present.

2. The method of claim 1, wherein signal stacks are processed to generate modified microseismic resonance signal that represents the multiple microseismic resonance signals.

3. The method of claim 1, wherein the signal stacks are processed to generate a mean microseismic resonance signal, an arithmetic mean microseismic resonance signal, a geometric mean microseismic resonance signal, a median microseismic resonance signal, a mid-point microseismic resonance signal, a microseismic resonance signal with outlier signal filtered out, or a combination thereof.

4. The method of claim 1, wherein the signal stacks are based on 2 to 10 sequentially obtained microseismic resonance signals.

5. (canceled)

6. The method of claim 1, wherein the resonance sensor is placed directly on the multiple surface locations where microseismic resonance emissions are measurable.

7. The method of claim 1, wherein a spike is driven through the multiple surface locations and into the subsurface region of interest at a depth ranging from at least one inch to a depth where microseismic resonance emissions are reliably measurable.

8. The method of claim 1, wherein amplifying the microseismic resonance signal includes amplification with a multi-stage amplifier.

9. The method of claim 8, wherein the multi-stage amplifier provides multiple levels of amplification up to at least 16:1 gain up to about 64:1 gain.

10. (canceled)

11. The method of claim 1, wherein filtering the microseismic resonance signal is carried out using a maximally flat magnitude filter.

12. The method of claim 1, wherein individual microseismic resonance signals are obtained onboard a microseismic resonance detector which also collects onboard location data from an onboard receiver adapted for use with a global navigation satellite system or with RF signal from terrestrial base station source and a second reference signal.

13-14. (canceled)

15. The method of claim 12, wherein the onboard location data collected on the microseismic resonance detector includes an onboard receiver adapted for real-time kinematic positioning.

16. The method of claim 1, wherein the resonance sensor has a sensitivity suitable for sensing frequencies within the range of about 4 Hz to about 800 Hz.

17. The method of claim 1, wherein amplifying the microseismic resonance signals and filtering out the high frequencies is carried out as analog signals to obtain the low frequencies, and wherein the low frequencies are converted to a digital signal for digital processing.

18. The method of claim 1, wherein at least some of the digital processing occurs onboard a microseismic resonance detector, at least some of the digital processing occurs remotely after transfer to a computer or a network, or both

19. (canceled)

20. The method of claim 1, wherein filtering out the high frequencies includes retaining all low frequencies below the high frequencies that are filtered out.

21. The method of claim 1, wherein the subsurface conditions conducive to fluid transfer indicates the presence of water, and wherein the method further comprises:
identifying the possibility of subsurface water using a gamma radiation detector where there is a reduced gamma radiation count relative to a background gamma radiation count,
identifying the possibility of subsurface water using magnetometric density, or
both.

22-23. (canceled)

24. The method of claim 1, wherein the subsurface conditions conducive to fluid transfer indicates the presence of oil, gas, or both.

25. The method of claim 1, wherein the resonance sensor is a piezoelectric sensor.

26. A method of detecting subsurface water or conditions conducive to subsurface water, comprising:
obtaining a gamma radiation count from multiple surface locations over a subsurface region of interest using a gamma radiation detector having an inorganic scintillation detector selected from a cesium halide crystal, cerium halide crystal, lanthanum halide crystal, or bismuth germinate crystal;
determining a background gamma radiation count over at least a portion of the subsurface region of interest; and
identifying a potential subsurface water location within the region of interest where a reduced gamma radiation count is present relative to the background gamma radiation count, and wherein the reduced gamma count is:
from about 5% to 100% less than the background gamma radiation count, from about 20 counts per second to about 500 counts per second, wherein the reduced gamma radiation count is from 5 counts per second to 75 counts per second lower than background gamma radiation count, or both.

27-28. (canceled)

29. The method of claim 26, wherein obtaining gamma radiation count occurs as the gamma radiation detector is moving over the subsurface region of interest.

30. The method of claim 26, wherein the gamma radiation detector groups the gamma radiation count in time increments and also collects onboard location data at least at a portion of the time increments.

31. The method of claim 30, wherein the onboard location data collected by the gamma radiation detector includes an onboard receiver adapted:
to receive global positioning signal for use with a global navigation satellite system,
to receive RF signal from a terrestrial base station source and a second reference signal,
for real-time kinematic positioning, or
a combination thereof.

32-33. (canceled)

34. The method of claim 26, wherein the gamma radiation count is collected at up to 100 feet above the multiple surface locations.

35. The method of claim 26, wherein the gamma radiation count is collected at up to 10 feet above the multiple surface locations.

36. The method of claim 26, wherein the inorganic scintillation detector is doped with thallium or cerium.

37. The method of claim 26, wherein the reduced gamma radiation count is a result of water vapor venting occurring within about 2 feet below surface location generally above the potential subsurface water location.

38. (canceled)

39. The method of claim 26, wherein the inorganic scintillation detector is the bismuth germinate crystal.

40. The method of claim 26, further comprising also identifying the possibility of subsurface water using; a microseismic resonance detector to detect subsurface fracture zones where subsurface water may be present, magnetometric density, or both.

41. (canceled)

42. A system of detecting subsurface conditions conducive to fluid transfer, comprising:
a microseismic resonance detector with a resonance sensor to obtain microseismic resonance signals from multiple surface locations over a subsurface region of interest;
an analog amplifier to amplify the microseismic resonance signals and a low pass filter to filter out high frequency microseismic resonance signal to generate amplified and filtered microseismic signal;
a processor; and
a memory storing instructions that, when executed by the processor, generates signal stacks from multiple measurements taken at single locations of the multiple surface locations.

43. The system of claim 42, wherein the memory is onboard the microseismic resonance detector, or present on a remote computer or computer network connectable with the microseismic resonance detector.

44. (canceled)

45. The system of claim 42, wherein the resonance sensor is a piezoelectric sensor.

46. A method of detecting subsurface fluid within an area of interest, comprising generating subsurface fluid information using two or three of the following:
(i) obtaining microseismic resonance signals from multiple surface locations over a subsurface region of interest,
(ii) obtaining a gamma radiation count from multiple surface locations over the subsurface region of interest using a gamma radiation detector and identifying potential subsurface fluid locations where reduced gamma radiation count is present relative to background gamma radiation count,
(ii) obtaining magnetometric density data based on a magnetic field generated by electric current passing through a hydrogeologic system of the subsurface region of interest.

47. The method of claim 46, wherein the method includes generating the subsurface fluid information via (i) obtaining the microseismic resonance signals, (ii) obtaining the gamma radiation count, and (iii) obtaining the magnetometric density data.

48. The method of claim 46, wherein (i) obtaining the microseismic resonance signal is carried out and the microseismic resonance signal is evaluated using frequencies at least as low as about 4 Hz to identify subsurface fracture zones where subsurface fluids may be present.

49. The method of claim 46, wherein (ii) obtaining the gamma radiation count is carried out and wherein:
the method further includes determining the background radiation count over at least a portion of the subsurface region of interest,
the gamma radiation detector has an inorganic scintillation detector selected from a cesium halide crystal, cerium halide crystal, lanthanum halide crystal, or bismuth germinate crystal, or both.

50. (canceled)

51. The method of claim 46, wherein (iii) obtaining magnetometric density data is carried out and the magnetometric density data is used to create a model of the electric current distribution.
